(19) United States
(12) Patent Application Publication
(10) Pub. No.: US 2023/0385687 A1
(43) Pub. Date: Nov. 30, 2023

(54) ESTIMATING OPTIMAL TRAINING DATA SET SIZE FOR MACHINE LEARNING MODEL SYSTEMS AND APPLICATIONS

(71) Applicant: NVIDIA Corporation, Santa Clara, CA (US)

(72) Inventors: Rafid Reza Mahmood, Mississauga (CA); James Robert Lucas, Toronto (CA); David Jesus Acuna Marrero, Toronto (CA); Daiqing Li, Oakville (CA); Jonah Philion, Toronto (CA); Jose Manuel Alvarez Lopez, Mountain View, CA (US); Zhiding Yu, Santa Clara, CA (US); Sanja Fidler, Toronto (CA); Marc Law, Toronto (CA)

(21) Appl. No.: 17/828,663

(22) Filed: May 31, 2022

(51) Int. Cl. G06N 20/00; G06K 9/62

(52) U.S. Cl. CPC G06N 20/00; G06K 9/6265

(57) ABSTRACT

Approaches for training data set size estimation for machine learning model systems and applications are described. Examples include a machine learning model training system that estimates target data requirements for training a machine learning model, given an approximate relationship between training data set size and model performance using one or more validation score estimation functions. To derive a validation score estimation function, a regression data set is generated from training data, and subsets of the regression data set are used to train the machine learning model. A validation score is computed for the subsets and used to compute regression function parameters to curve fit the selected regression function to the training data set. The validation score estimation function is then solved for and provides an output of an estimate of the number additional training samples needed for the validation score estimation function to meet or exceed a target validation score.

### BACKGROUND

Machine learning models are used in electronic devices for a variety of purposes, such as image classification, object detection, segmentation, content creation, navigation, and other tasks. Machine learning models learn to perform such tasks through a process by which they are trained using training data. Before a machine learning model is deployed in a user device, validation is performed to ensure that the machine learning model meets at least a target validation performance. For example, an object detection machine learning model may need to satisfy a minimum mean average precision before being deployed in a safety-critical application.

For a machine learning model, there may be a correlation between its validation performance and the amount of training data used in training. For a model that does not initially meet a target validation performance, a common technique to increase the validation performance is by collecting more training data to further train the model. However, collecting and annotating data used for training machine learning models can be both expensive and time consuming. For example, annotating segmentation data sets may require, e.g., 15 to 40 seconds per object such that annotating a driving data set of 100,000 images with on average 10 cars per image can take an amount of time equivalent to between 170 and 460 days. Overestimating the amount of additional data needed to meet a target validation performance can therefore cause the designer to incur unnecessary costs and man hours, while also requiring significant computing resources (e.g., processing power, storage, etc.). Moreover, over-training machine learning models can degrade the model's ability to generalize beyond its training data. In contrast, underestimating the amount of additional data needed to meet a target validation performance can result in the need to collect still more data at a later stage, incurring further computational overhead and workflow delays. As such, it is important to determine how much additional training data is needed for a machine learning model to achieve a target validation performance.

### SUMMARY

Embodiments of the present disclosure relate to training data set size estimation for machine learning model systems and applications. Systems and methods of the present disclosure may assist in determining the amount of additional training data needed when a machine learning model tests below a target validation performance after training with an initial set of training data.

In contrast to conventional systems, the systems and methods presented in this disclosure are directed to a training data collection estimation function that estimates target data requirements for training a machine learning model, given an approximate relationship between training data set size and model performance using one or more validation score estimation functions. Validation score estimation functions may comprise, for example, concave monotonic increasing regression functions, such as but not limited to power law, arctan, logarithmic, and/or algebraic root regression functions. In order to derive a validation score estimation function that is calibrated to a training data set, a regression data set is generated from the training data set, and subsets of the regression data set are used to train the machine learning model. A validation score is computed for each subset and used to compute regression function parameters to curve fit the selected regression function to the training data set. The validation score estimation function is then solved for a value of n, which is an estimate of the number additional training samples needed for the validation score estimation function to meet or exceed a target validation score.

In some embodiments, a correction factor, τ, may be added to the target validation score prior to computing \hat{n} to bias the validation score estimation function to yield a larger—that is, a more pessimistic—estimate of the number of additional training samples needed. In some embodiments, estimating the number n of additional training samples needed may be bounded by computing \hat{n} from a plurality of different validation score estimation functions, including both optimistic and pessimistic concave monotonic increasing regression functions. The solutions presented herein provide for training of a machine learning model using a training data set of sufficient size to obtain a target validation score, while avoiding overestimating the amount of additional data needed. As a result, and in contrast to conventional solutions that waste large quantities of computing resources (e.g., processing power, storage, etc.) and/or over train machine learning models, the systems and methods of the present disclosure limit the compute and human resources to those that allow the model to satisfy a target validation score, while avoiding over training.

### BRIEF DESCRIPTION OF THE DRAWINGS

The present systems and methods for training data set size estimation for machine learning model systems and applications are described in detail below with reference to the attached drawing figures, wherein:

FIG. 1 is an illustration of an example flow diagram for a machine learning model training system, in accordance with some embodiments of the present disclosure;

FIG. 2 is an illustration of an example process flow for computing an estimate of the additional training samples, in accordance with some embodiments of the present disclosure;

FIG. 3 is flow chart illustrating a method for training data set size estimation for machine learning models, in accordance with some embodiments of the present disclosure;

FIG. 4 is an illustration of an example process flow for computing a linear score function of ground truth for use in conjunction with generating an estimate of additional training samples, in accordance with some embodiments of the present disclosure;

FIG. 5 is an illustration of an example process flow for computing a bounding set of estimates of additional training samples, in accordance with some embodiments of the present disclosure;

FIG. 6 is an illustration of a user interface displayed on a human machine interface for use in conjunction with generating estimates of additional training samples, in accordance with some embodiments of the present disclosure;

FIG. 7 is a block diagram of an example computing device suitable for use in implementing some embodiments of the present disclosure; and

FIG. 8 is a block diagram of an example data center suitable for use in implementing some embodiments of the present disclosure.

### DETAILED DESCRIPTION

Systems and methods are disclosed related to training data set size estimation for machine learning model systems and applications. The present disclosure relates to estimating the amount of training data to collect in order to train a machine learning model to meet a target validation performance. The validation performance of the machine learning model may relate to performance metrics such as, but not limited to, accuracy, precision, recall, Intersection over Union (IoU), or other performance metric(s). Systems and methods presented in this disclosure may assist in determining the amount of additional training data needed when a machine learning model tests below the target validation performance after training with an initial set of training data. In some embodiments, regression functions may be computed based at least on samples selected from the initial set of training data to derive one or more validation score estimation functions, from which an estimate of the number of additional training samples needed to meet the target validation performance can be determined.

The systems and methods presented in this disclosure are directed to a training data collection estimation function—that may be executed on user devices and/or in cloud computing environments—that estimates target data requirements given an approximate relationship between training data set size and model performance. These estimates may be computed using one or more validation score estimation functions, such as a power law function. The training data collection estimation function predicts a training data collection budget that is estimated to return a target model validation score after a limited number of training rounds.

For example, an initial training data set D₀:={zᵢ}ᵢ₌₁ⁿ^{₀} for training a model f may comprise n₀ points, where z:=(x, y) with images “x” and labels “y.” The training goal for training model f is to obtain a validation score, V*, which is computed from V_{f}(D), the validation score function of the model f after it is trained on set D. If after training model f with D₀, the validation score is found to be less than V*, then the training data collection estimation function presented by this disclosure may be used to determine the number of additional sample points \hat{n} of additional training data \hat{D} that can be expected to yield a validation score of V_{f}(D₀∪\hat{D})>V* for the model

In some embodiments, in order to derive a validation score estimation function, V_{f-est} (D), a regression data set, R, comprising r subsets S is generated from D₀ (where S₀⊂S₁ . . . ⊂Sᵣ₋₁=D₀), and a validation score V_{f}(S) is computed for each subset S by training the model f using each subset S and computing the resulting validation score of the trained model f. Using the resulting (S, V_{f} (S)) pairs, the parameters, θ, for at least one concave monotonic increasing regression function are computed. For example, for a power law regression function of \hat{v}(n; θ)=θ₁n^{θ}^{₂}+θ₃, curve fitting may be applied using the (S, V_{f} (S)) pairs to compute parameters θ:={θ₁, θ₂, θ₃}. Other concave monotonic increasing regression functions that may be used for a validation score estimation function, V_{f-est}(D), include, but are not limited to, Arctan, Logarithmic, and Algebraic Root, regression functions.

Given the computed parameters θ, a validation score estimation function V_{f-est}(n; θ) can be defined as V_{f-est}(n; θ)=\hat{v}(n; θ), and the relationship V*=V_{f-est}(n; θ) can be solved for n to estimate the number, \hat{n}, of additional training samples D needed to obtain a validation score of at least V*. In some embodiments, \hat{n} is minimized by the training data collection estimation function subject to \hat{v}(\hat{n}; θ)>V*. For the next round of training, \hat{n} new training points are collected to obtain \hat{D}, the model f is trained using (D₀∪D), and V_{f}(D₀∪\hat{D}) computed. If the new validation score has sufficiently improved to now exceed V*, then the processes is completed. If the new validation score has not sufficiently improved to exceed V*, then the validation score estimation function V_{f-est}(n; θ) may be re-determined (e.g., refit) based at least on training data (D₀∪\hat{D}), and a new \hat{n} may be computed. This sequence may be repeated until V_{f}(D₀∪\hat{D})>V* is obtained, or until a predetermined permitted maximum of T rounds is reached.

In some embodiments, as the collected set of training data grows, an error, ϵ, of \hat{n} can be estimated by the training data collection function based at least on a linear score function of ground truth, such as:

$$v ( n ) = \{ \begin{matrix}\frac{{V}_{f} ( {D}_{0} )}{{n}_{0}} n , & n \leq {n}_{0} \\ \frac{{V}_{f} ( {D}_{i} ) - {V}_{f} ( {D}_{i - 1} )}{{n}_{i} - {n}_{i - 1}} ( n - {n}_{i} ) + {V}_{f} ( {D}_{i} ) , & {n}_{i - 1} \leq n \leq {n}_{i}\end{matrix}$$

where D₀⊂D₁⊂D₂ . . . is an ascending sequence of data sets, nᵢ=|Dᵢ| for each i in the sequence, and v(n) is a concave and monotonically increasing function. Given this linear score function of ground truth, n* signifies the smallest value satisfying v(n₀+n*)=V*. An error, ϵ(\hat{n}), may be computed, for example, based at least on a difference between V_{f-est}(\hat{n}; θ) as computed from the power law (or other selected regression function) and the v(\hat{n}) from the linear score function. The estimated error ϵ(\hat{n}) may be displayed to the model designer in a user interface along with the value of \hat{n}. For example, if the validation score from linear score function v(\hat{n}) indicates a value lower than the training goal validation score, V*, the designer may elect to collect slightly more than the \hat{n} additional samples of training data suggested from solving V*=V_{f-est}(n; θ). In at least one embodiment, the designer may select, using the user interface, one or more options to generate synthetic training data and/or to augment existing training data based at least on the training goal validation score, V*, and/or the system may automatically generate the synthetic training data and/or augment the existing training data based at least on the training goal validation score, V*.

In some embodiments, a correction factor, τ, may be added to the training goal validation score, V*, prior to computing n from the validation score estimation function. That is, the training data collection estimation function solves for a value of \hat{n}60 satisfying V*+τ=V_{f-est} (n; θ) and/or minimizes \hat{n} subject to \hat{D}(n₀+\hat{n}; θ)>V*+τ after each round of data collection and training. In order to determine how large the correction factor, τ, should be, the training data collection estimation function may treat the correction factor as a hyper-parameter. For example, in some embodiments, a data collection ratio may be computed for the validation score estimation function versus the minimum data required according to the ground truth linear score function v(n). This data collection ratio may be expressed as:

(n₀+\hat{n})/(n₀+n*).

The data collection ratio thus may be a function of the validation score estimation function, the training goal validation score V*, and the machine learning model/task/algorithm. In evaluating how a particular validation score estimation function, V_{f-est}(n; θ), collects data, when the data collection ratio is less than one for different targets and machine learning tasks, the validation score estimation function is described as being an optimistic predictor of the validation score, which means that solving for \hat{n} will under-estimate how much additional training data will be needed. In contrast, a data collection ratio greater than one for a range of different targets and machine learning tasks means that the validation score estimation function is a pessimistic predictor of the validation score. Solving for \hat{n} from a pessimistic validation score estimation function may over-estimate \hat{n}, and thus over-estimate how much additional training data will be needed. An ideal validation score estimation function may achieve the smallest data collection ratio greater than one. One problem associated with over-estimating \hat{n} from a pessimistic validation score estimation function is that the amount of overestimation is potentially boundless due to the increasing flatness of validation scores estimated from concave monotonic increasing regression functions as the data set size increases. As a result, solving a pessimistic validation score estimation function for even a small desired improvement in a validation score could potentially lead to an overestimation of \hat{n} by an order of magnitude or more. Accordingly, in some embodiments, a value for the correction factor, τ, can be computed starting with an optimistic validation score estimation function V_{f-est}(n; θ), and iteratively solving V*+τ=V_{f-est}(n; θ) using increasing values for the correction factor, τ, until the data collection ratio exceeds one. This fitted correction factor, τ, may then be used as a correction factor while estimating the number \hat{n} of additional training samples D needed to obtain a validation score of at least V*.

In some embodiments, a correction factor, τ, may be estimated based at least on prior training data sets collected for separate, but similar, tasks. For example, the current task may involve the classification of medical images. A prior training data set may have been collected for classification of a different type of medical image and known to produce a passing validation score (e.g. at least V*) on a similar machine learning model architecture. That prior data set may be sampled to obtain a subset of the approximate size of Do and that subset fit to a validation score estimation function V_{f-est}(n; θ) being used for the current task. The resulting validation score estimation function V_{f-est}(n; θ) fit using the prior data set may be used to iteratively solve V*+τ=V_{f-est}(n; θ) for a correction factor, τ, that yields a data collection ratio that just exceeds a value of one (e.g., a data collection that exceeds a value of one by a predetermined threshold value). The correction factor, τ, computed from the prior training data set for the similar but separate task may be used as the correction factor, τ, to solve V*+τ=V_{f-est}(n; θ) for \hat{n} using the current data set being collected for the current task.

In some embodiments, estimating the number \hat{n} of additional training samples D needed may be bounded by computing \hat{n} from a plurality of different validation score estimation functions, including, e.g., both optimistic and pessimistic concave monotonic increasing regression functions. The different validation score estimation functions may yield an ensemble of \hat{n} predictions with the largest prediction providing a worst-case estimate and the smallest prediction providing a best-case estimate. Each of these \hat{n} predictions can be displayed in the user interface to the user (e.g., the model designer) to provide an indication of how well the \hat{n}predictions are bounded. Power law, logarithmic, and algebraic root, regression functions are generally known from empirical observations to be optimistic for many tasks, while arctan regression functions are generally known from empirical observations to often be pessimistic for many tasks. That said, these generalizations are not always true for all tasks. The optimism or pessimism of a concave monotonic increasing regression functions may be determined for a set of tasks by computing their respective data collection ratio as discussed above.

The training data collection estimation function and its corresponding methods may be executed, for example, at least in part on at least one graphics processing unit (GPU) that may operate in conjunction with software executed on a central processing unit (CPU) coupled to a memory. The graphics processing unit may be programmed to execute the machine learning model used with the regression data set to derive the validation score estimation function, V_{f-est} (n; θ), from the regression data set. Other computations may be executed by the software executing on the CPU. In some embodiments, one or more aspects of the training data collection estimation function are performed via a cloud computing environment accessed by a user device via a network. For example, in some embodiments, the machine learning model used by the training data collection estimation function may be implemented as a virtual function on the cloud computing environment. As such, in some embodiments, the training data collection estimation function may be implemented as a component of a virtualized machine learning model training simulation environment.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

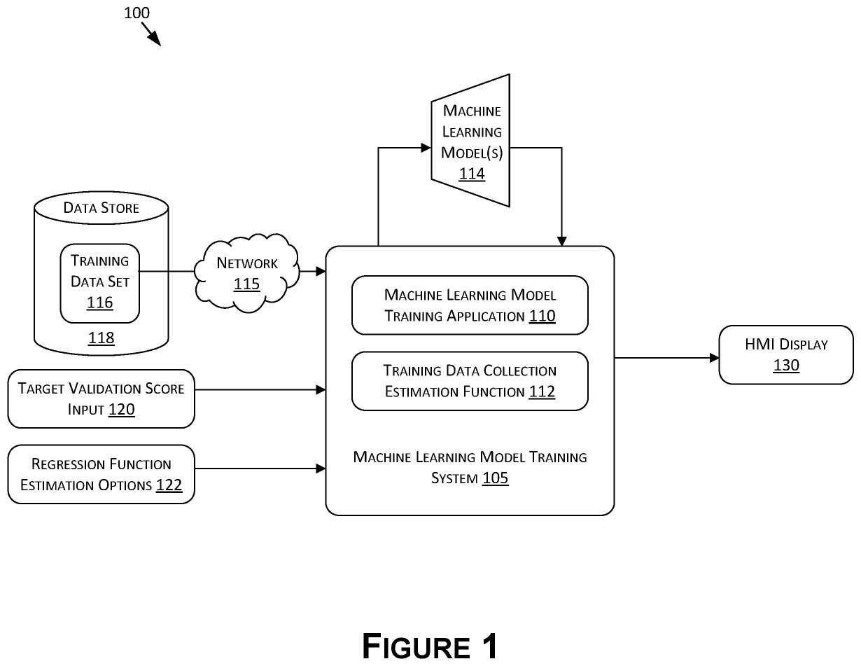

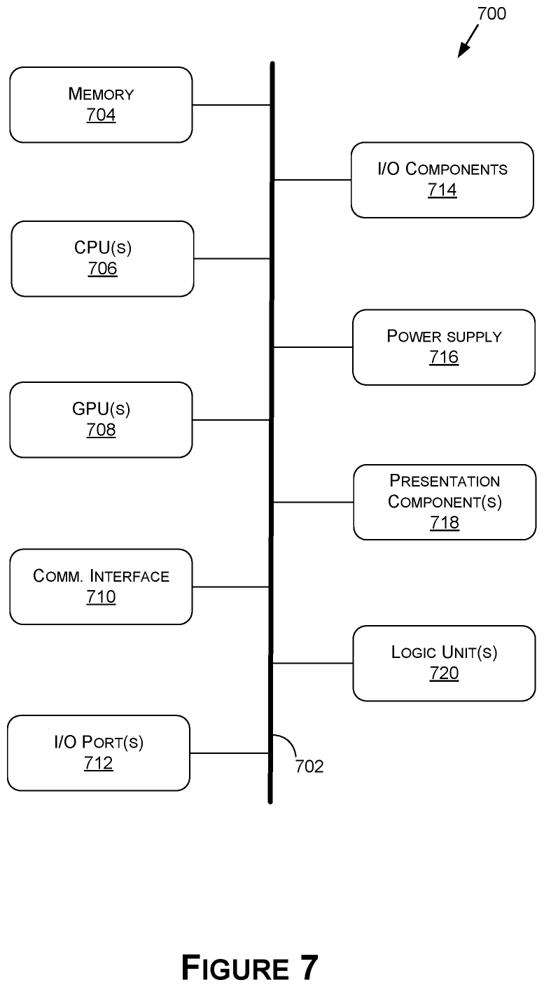

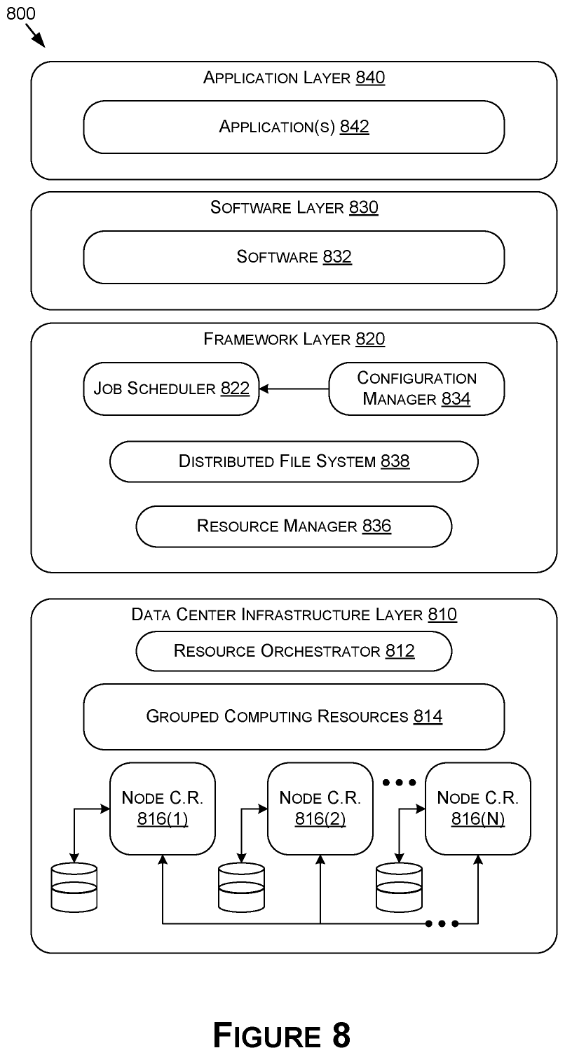

With reference to FIG. 1, FIG. 1 is an example data flow diagram 100 for a machine learning model training system 105, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described in FIG. 1 and/or elsewhere herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the system 105 may include similar components, features, and/or functionality to that of example computing device 700 of FIG. 7 and/or example data center 800 of FIG. 8.

Among other components not shown, the operating environment 100 may include a machine learning model training system 105 that comprises a machine learning model training application 110 and a training data collection estimation function 112, which may be coupled to a machine learning model 114. The machine learning model 114 comprises one or more machine learning models that are under training by the machine learning model training system 105. The machine learning model(s) 114 may be trained by the machine learning model training system 105 using a training data set 116, which in some embodiments may reside on a data store 118. The machine learning model 114 is not restricted to any particular machine learning model architecture or neural network structure and may comprise, for example and without limitation, a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, one or more neural networks (e.g., auto-encoders, convolutional, recurrent, perceptrons, Long/Short Term Memory (LSTM), Hopfield, Boltzmann, deep belief, deconvolutional, generative adversarial, and/or liquid state machine, etc.), and/or other types of machine learning models.

In some embodiments, the data store 118 may be an element of the machine learning model training system 105. In some embodiments, the data store 118 may be coupled to the machine learning model training system 105 by a network 115. By way of example, network 115 may include one or more wide area networks (WANs), one or more local area networks (LANs), one or more public networks such as the Internet, and/or one or more private networks.

Each of the components shown in FIG. 1 can be implemented via any type of computing device. In particular, the machine learning model training application 110 together with training data collection estimation function 112, may be implemented on any type of computing device capable of being operated, either locally or remotely, by a user. For example, in some embodiments, one or more aspects of the machine learning model training system 105 may be implemented by a computing device 700 as shown in FIG. 7, and/or as components implemented via the computing resources of a data center 800 as shown in FIG. 8. Although the machine learning model training application 110 and the training data collection estimation function 112 are illustrated as singular entities for simplicity, the functionalities attributed to these elements herein may be distributed across one or more applications in practice. In some embodiments, the training data collection estimation function 112 is a component of the machine learning model training application 110.

The machine learning model training application 110 can generally be any application capable of facilitating training of a machine learning model 114 using the techniques described herein and/or other techniques, either on its own, or via an exchange of information with other elements (e.g., via the network 115). In some implementations, the machine learning model training application 110 comprises a web application, which can run in a web browser, and could be hosted at least partially on a server-side of environment 100, such as by the data center 800. In addition, or instead, the machine learning model training application 110 can comprise a dedicated machine learning model training application.

In some embodiments, in operation, the machine learning model training application 110 receives the training data set 116 and applies training samples of the training data set 116 to train the machine learning model 114 and compute a validation score for the trained machine learning model 114 (e.g., using cross-validation or other validation technique). In some embodiments, the validation score is computed using a testing data set that comprises a separate portion of the training data set 116 from which the training samples are derived. The validation score is a metric indicating an estimate of how well the machine learning model is expected to perform when provided previously seen input data. For example, a machine learning model trained for a classification problem will have a validation score indicating a probability that the model will correctly classify an image. In some embodiments, once the validation score is computed by the machine learning model training application 110, a validation score output may be generated by the machine learning model training application 110 for display to a user via a human machine interface (HMI) display 130 (such as presentation component 718, for example).

As discussed above, in some implementations, training the machine learning model 114 will yield a validation performance that is below a target validation performance (e.g., a target validation score). At that point, the model designer (e.g., a user of machine learning model training system 105) may need to determine the number of additional training samples (e.g., \hat{n}) needed for the machine learning model 114 to meet the target validation score. Overestimating the amount of additional data needed to meet a target validation performance can cause the designer to incur substantial unnecessary costs, while wasting large quantities of computing resources (e.g., processing power, storage, etc.). Over training the machine learning model 114 can also degrade the model's ability to generalize beyond its training data. In contrast, underestimating the amount of additional data needed to meet the target validation score can result in the need to collect additional data samples for the training data set 116 at a later stage, incurring further computational overhead and workflow delays.

In the embodiment of FIG. 1, the number of additional training samples (e.g., \hat{n}) needed for the machine learning model 114 to meet the target validation score may be estimated by the training data collection estimation function 112. That is, the training data collection estimation function 112 is programmed to input a target validation score, V* (shown at 120) and estimate the number of additional training samples (e.g., \hat{n}) using one or more concave monotonic increasing regression functions, as described herein. In some embodiments, the target validation score, V*, may be received as a user input via the HMI display 130. In some embodiments, additional user input (e.g., via the HMI display 130) may comprise regression function estimation options 122 including, but not limited to, a correction factor, τ, which may be added to the training goal validation score, V*, options to select which of the one or more of the concave monotonic increasing regression functions to use for computing he number of additional training samples, \hat{n}, and/or one or more options for machine learning model training system 105 to generate synthetic training data and/or to augment existing training data set 116 based at least on the target validation score, V*.

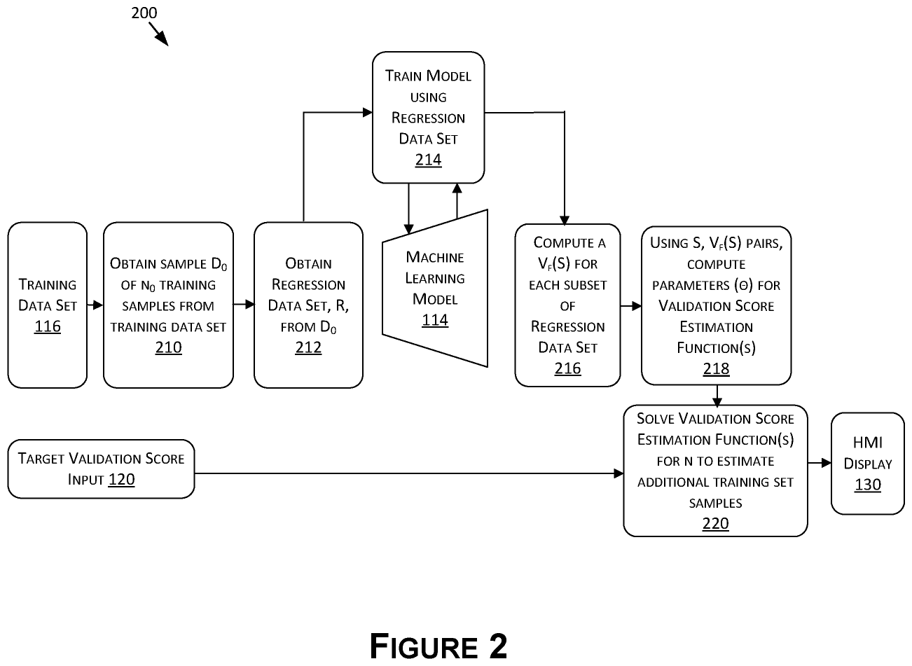

Now referring to FIG. 2, an example process flow performed by the training data collection estimation function 112 for computing an estimate of the additional training samples, \hat{n}, is shown at 200. The machine learning model 114 is reinitialized and retrained using a regression data set, R. In some embodiments, a sample D₀ of n₀ training samples is obtained from the training data set 116 (as shown at 210). The regression data set comprises a plurality of subsets generated from the sample D₀. In some embodiments, at 212, a regression data set, R, comprising r subsets S is generated from D₀ (where S₀⊂S₁ . . . ⊂Sᵣ₋₁). At 214, the machine learning model 114 is iteratively retrained using each of the subsets S (S₀, S₁, Sᵣ₋₁) and a validation score of the machine learning model 114 from training using each of the subsets is computed at 216 (e.g. by the machine learning model training application 110). The result of the computation is a validation score V_{f}(S) for each subset S of the regression data set, R, defining a set of resulting (S, V_{f}(S)) pairs.

Using the (S, V_{f}(S)) pairs, training data collection estimation function 112, at 218, computes the parameters, θ, to derive at least one concave monotonic increasing regression function that it will use as a validation score estimation function, V_{f-est}(D). In some embodiments, the training data collection estimation function 112 may derive a validation score estimation function by curve fitting the plurality of validation scores (e.g., using the (S, V_{f}(S)) pairs) to compute the one or more parameters θ for the selected validation score estimation function(s). For example, for a power law regression function of \hat{v}(n; θ)=θ₁n^{θ}^{₂}+θ₃, curve fitting may be applied using the (S, V_{f}(S)) pairs to compute parameters θ:={θ₁, θ₂, θ₃}. For an Arctan regression function of

$$\hat{v} ( n ; θ ) = \frac{200}{π} arctan ( {θ}_{1} \frac{π}{2} n + {θ}_{2} ) + {θ}_{3} ,$$

curve fitting may be applied using the (S, V_{f} (S)) pairs to compute parameters θ:={θ₁, θ₂, θ₃}. For a Logarithmic regression function of \hat{v}(n; θ)=θ₁^{π}log(n+θ₂)+θ₃, curve fitting may be applied using the (S, V_{f} (S)) pairs to compute parameters θ:={θ₁, θ₂, θ₃}. For an Algebraic Root regression function of

$$\hat{v} ( n ; θ ) = \frac{100 n}{{( 1 + {\vert {θ}_{1} n \vert}^{{θ}_{2}} )}^{1 / {θ}_{2}}} + {θ}_{3} ,$$

curve fitting may be applied using the (S, V_{f}(S)) pairs to compute parameters θ:={θ₁, θ₂, θ₃}. In other embodiments, training data collection estimation function 112 may compute the parameters 0 for one or more other concave monotonic increasing regression functions.

In some embodiments, the training data collection estimation function 112, at 218, computes the parameters θ for one or more concave monotonic increasing regression functions selected by the user(s) as indicated by the regression function estimation options 122. That is, the training data collection estimation function 112 may receive as input a selection of the power law, Arctan, Logarithmic, Algebraic Root, and/or other regression functions and derive at least one validation score estimation function V_{f-est}(D) based on the selection.

Given the computed parameters 0 from 218, a validation score estimation function V_{f-est}(n; θ) can be defined as V_{f-est}(n; θ)=\hat{v}(n; θ) and the relationship V*=V_{f-est}(n; θ) solved for n at 220 to estimate the number, \hat{n}, of additional training samples \hat{D} needed to obtain a validation score of at least V*. In some embodiments, \hat{n} is minimized by the training data collection estimation function 112 subject to \hat{v}(\hat{n}; θ)≥V*. Once computed, the estimate \hat{n} for each validation score estimation function V_{f-est}(n; θ) selected may be passed from the training data collection estimation function 112 to the machine learning model training application 110 for display to the user via HMI display 130.

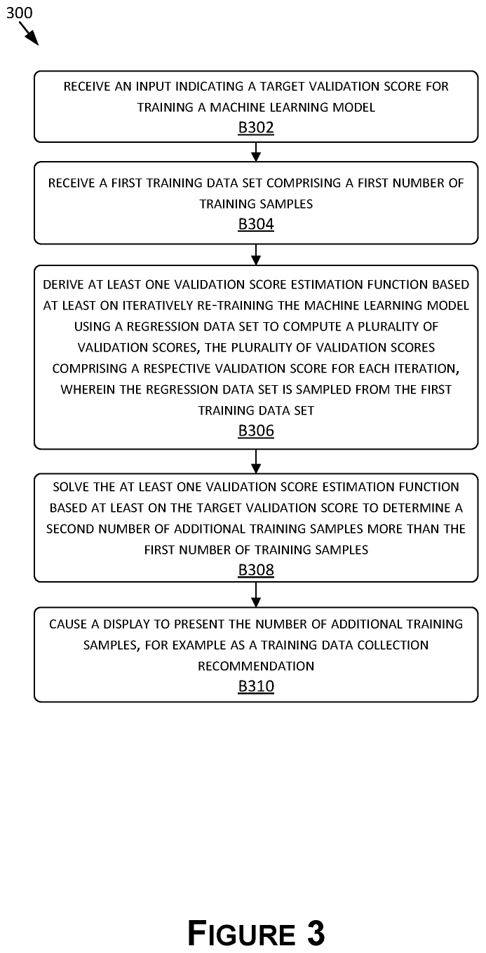

Now referring to FIG. 3, each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for training data set size estimation for machine learning models, in accordance with some embodiments of the present disclosure. It should be understood that the features and elements described herein with respect to the method 300 of FIG. 3 may be used in conjunction with, in combination with, or substituted for elements of, any of the other embodiments discussed herein and vice versa. Further, it should be understood that the functions, structures, and other descriptions of elements for embodiments described in FIG. 3 may apply to like or similarly named or described elements across any of the figures and/or embodiments described herein and vice versa.

The method 300, at block B302, includes receiving an input indicating a target validation score for training a machine learning model, and, at B304, includes receiving a first training data set comprising a first number of training samples. If, after training a machine learning model using the first number of training samples, the validation score is found to be less than the target validation score, then an estimate of the number of additional sample points \hat{n} of additional training data to satisfy the target validation score may be computed.

In some embodiments, the method 300 therefore includes, at B306, deriving at least one validation score estimation function based at least on iteratively re-training the machine learning model using a regression data set to compute a plurality of validation scores. The regression data set may be sampled from the first training data set. The plurality of validation scores may comprise a respective validation score for each iteration. In some embodiments, the derivation of the at least one validation score estimation function comprises curve fitting the plurality of validation scores to compute one or more parameters of the at least one validation score estimation function. The method 300 includes, at B308, solving the at least one validation score estimation function based at least on the target validation score to determine a second number of additional training samples. That second number of addition training samples defines \hat{n}, the number of additional training samples D needed for the machine learning model to meet the target validation score. In some embodiments, \hat{n} is minimized by the method subject to \hat{v}(\hat{n}; θ)≥V*. At B310, the method 300 includes causing a display to present the number of additional training samples, for example as a training data collection recommendation.

For the next round of training, \hat{n} new training points may be collected to obtain \hat{D}. The machine learning model may be retrained using (D₀∪\hat{D}), and the validation score V_{f}(D₀∪\hat{D}) recomputed for the machine learning model. If the new validation score has sufficiently improved to now exceed the target validation score, V*, then the method 300 is completed. Instead, if the new validation score has not sufficiently improved to exceed V*, then the method returns to block B306 to again derive at least one validation score estimation function based on a training data set that now includes the first number of training samples plus the additional training samples (e.g., (D₀∪\hat{D})). At each iteration of the method 300, the total number of training samples grows in size as \hat{D} cumulatively includes the additional training samples collected from each round. The method 300 may be repeated until a V_{f}(D₀∪\hat{D})>V* is obtained, or until a predetermined permitted maximum of T rounds is reached.

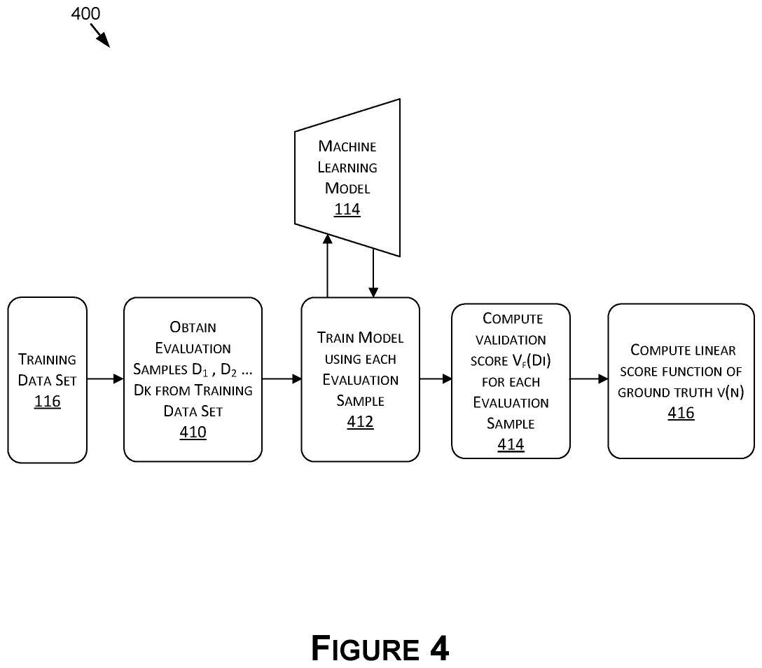

Now referring to FIG. 4, an example process flow performed by the training data collection estimation function 112 for computing a linear score function of ground truth is shown. In some embodiments, as the training data set 116 grows each time more training samples \hat{D} are collected, a set of evaluation samples D₀, D₁, D₂, . . . may be defined at each training iteration from D₀∪\hat{D}, (as shown at 410) where D₀⊂D₁⊂D₂ . . . is an ascending sequence of data sets, nᵢ=|Dᵢ| for each i in the sequence.

At 412, the machine learning model 114 is reinitialized and retrained using each of the i sets of evaluation samples and at 414, a validation score V_{f}(Dᵢ) computed for each of the i sets of evaluation samples Dᵢ. At 416, a piecewise linear score function of ground truth may then be computed as:

$$v ( n ) = \{ \begin{matrix}\frac{{V}_{f} ( {D}_{0} )}{{n}_{0}} n , & n \leq {n}_{0} \\ \frac{{V}_{f} ( {D}_{i} ) - {V}_{f} ( {D}_{i - 1} )}{{n}_{i} - {n}_{i - 1}} ( n - {n}_{i} ) + {V}_{f} ( {D}_{i} ) , & {n}_{i - 1} \leq n \leq {n}_{i}\end{matrix}$$

From this linear score function of ground truth, n* may be computed that signifies the smallest value satisfying v(n₀+n*)=V*. In some embodiments, the training data collection estimation function 112 may use the computed n* to compute the data collection ratio for the validation score estimation function (e.g., V_{f-est}(n; θ)) using (n₀+\hat{n})/(n₀+n*). In some embodiments, the training data collection estimation function 112 may use the data collection ratio to suggest a value for the correction factor, τ, that may be added to the training goal validation score, V*, prior to computing \hat{n} from the validation score estimation function, as discussed herein. The training data collection estimation function 112 may solve for a value of \hat{n} satisfying V*+τ=V_{f-est}(n; θ) and/or minimize \hat{n} subject to \hat{v}(n₀+\hat{n}; θ)≥V*+τ after each round of data collection and training. In some embodiments, the training data collection estimation function 112 may compute a correction factor, τ, by iteratively solving V*+τ=V_{f-est}(n; θ) using increasing values for the correction factor, τ, until the data collection ratio exceeds one. This fitted correction factor, τ, may then be used as a correction factor while estimating the number \hat{n} of additional training samples D needed to obtain a validation score of at least the target validation score, V*.

In some embodiments, the training data collection estimation function 112 may compute an error c(n) as a function of a difference between \hat{n} verses n* and/or V_{f-est}(\hat{n}; θ) verses v(\hat{n}). The estimated error ϵ(\hat{n}) may be displayed by a user interface via the HMI display 130 to further provide to the designer a degree of confidence in the value of \hat{n} before they perform the task of collecting and/or generating additional training samples.

In at least one embodiment, a user (e.g., designer) may select (e.g., using a user interface presented on the HMI display 130), one or more options to generate synthetic training data and/or to augment existing training data set 116. For example, in some embodiments, the machine learning model training system 105 may generate \hat{n} synthetic additional training samples \hat{D} using one or more data set augmentation techniques and/or synthetic training data generation techniques. For example, in some embodiments, the machine learning model training application 110, or other component of machine learning model training system 105, may input existing training samples from the training data set 116 and apply cropping, rotations, translations, or other modification, to create new training samples. In some embodiments, synthetic training data may be generated using three-dimensional (3D) rendering training data techniques. Using such synthetic training samples to generate the \hat{n} synthetic additional training samples \hat{D} may be less time consuming and more practical than collecting \hat{n} additional training samples D from real-world environments. The designer may also optionally re-compute V_{f-est}(n; θ) using (D₀∪\hat{D}), where \hat{D} includes the \hat{n} synthetic additional training samples, to gain confidence that collecting \hat{n} real-world additional training samples would yield the desired target validation score. That is, if V_{f-est}(D₀∪\hat{D}) using \hat{n} synthetic additional training samples provided the desired target validation score, V*, then the designer could have a high degree of confidence that collecting \hat{n} real-world additional training samples should produce the desired target validation score, V*, after the next training iteration.

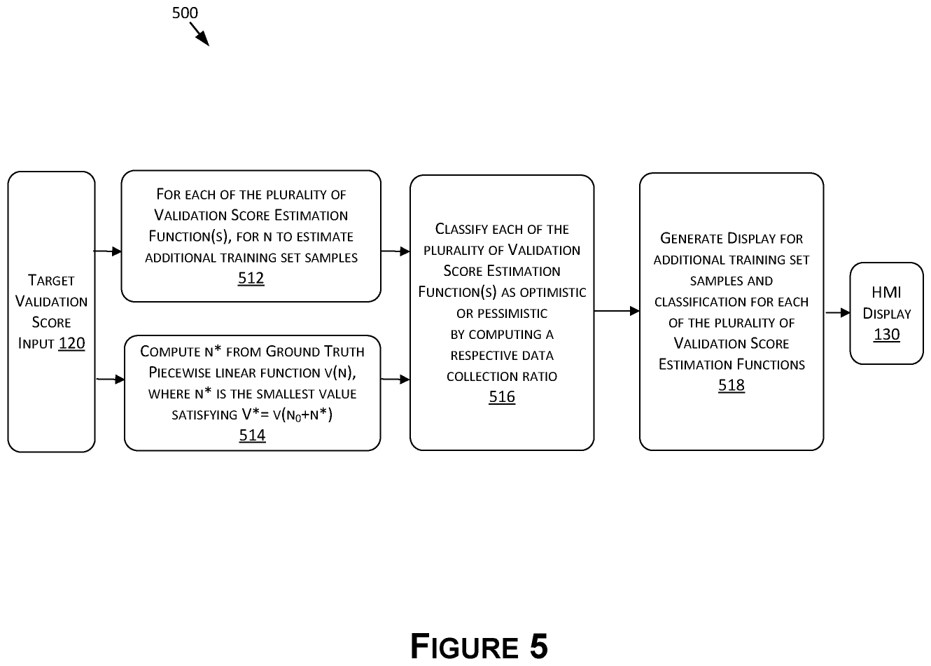

Now referring to FIG. 5, an example process flow for a process 500 performed using the training data collection estimation function 112 for computing a bounding set of estimates of additional training samples, \hat{n}. Given the user supplied target validation score input 120, the training data collection estimation function 112 derives a plurality of different validation score estimation functions, V_{f-est}(n; θ), for example, using the example process flow 200 performed by the training data collection estimation function 112, as shown in FIG. 2. As shown at 512, using the example process flow 200, each of the plurality of validation score estimation functions are solved for \hat{n} based at least on the target validation score input 122. The plurality of different validation score estimation functions may comprise concave monotonic increasing regression functions such as power law, logarithmic, arctan, algebraic root, and/or other concave monotonic increasing regression functions. The plurality of different validation score estimation functions may include both optimistic and pessimistic concave monotonic increasing regression functions. Some regression functions, such as the power law regression function, are known to generally compute optimistic validation scores. Other regression functions, such as the arctan regression function, are known to generally compute pessimistic validation scores. In some embodiments, the training data collection estimation function 112 may determine whether a validation score estimation function is currently behaving as an optimistic or pessimistic regression function. For example, as shown at 514, the process flow 200 may compute n* (the smallest value satisfying v(n₀+n*)=V*), which may be computed from the linear score function of ground truth (e.g., as illustrated by the example process flow of FIG. 3). The training data collection estimation function 112 may then compute (at 516) a respective data collection ratio (e.g., from (n₀+\hat{n})/(n₀+n*) for each of the plurality of different validation score estimation functions, which will indicate whether the respective validation score estimation functions associated with the data collection ratio is an optimistic or pessimistic regression function with respect to machine learning model validation scores for the current training data set 116. The different validation score estimation functions will yield an ensemble of \hat{n} predictions with the largest prediction providing a worst-case estimate and the smallest prediction providing a best-case estimate, thus bounding a range of \hat{n} predictions within which a value of n may be found that will satisfy the target validation score, V*. Each of these \hat{n} predictions can be displayed (at 518) in the user interface provided by HMI display 130 along with the optimistic or pessimistic of the respective regression function to provide an indication of how well the \hat{n} predictions are bounded.

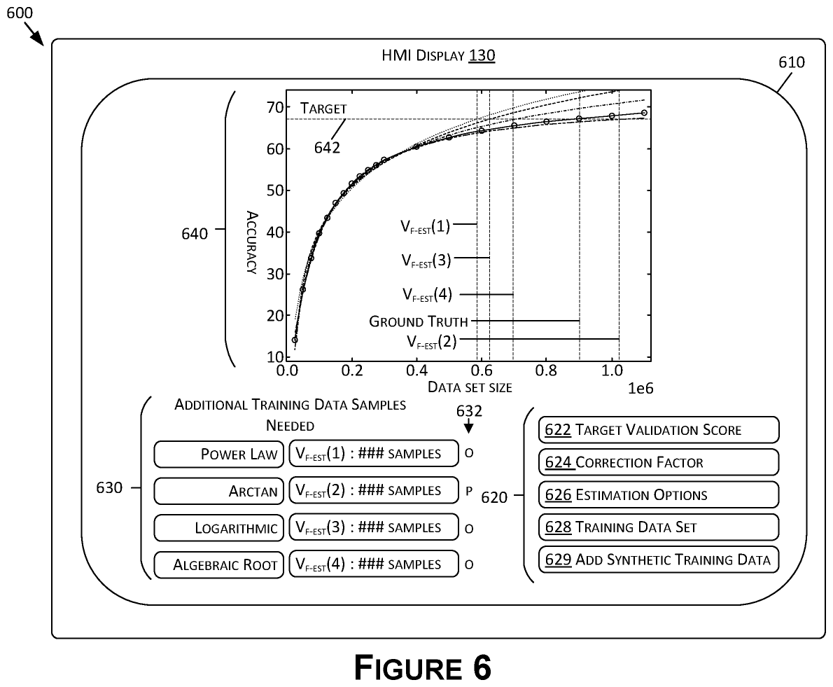

Referring now to FIG. 6, FIG. 6 illustrates, at 600, an example user interface 610 that may be generated by the machine learning training application 110, and presented, for example, on the HMI display 130. At 620, the user interface 610 includes one or more user input elements. For example, the user input elements 620 may receive a user input 622 to enter a target validation score, a user input 624 to enter a correction factor, and/or a user input 626 to enter other regression function estimation options, such as to select one or more regression functions to be used by the training data collection estimation function 112 as validation score estimation functions to estimate \hat{n}. The user input elements 620 may also receive a user input 628 to specify the training data set 116 to be used for training the machine learning model 114, and/or a user input 629 to request that the machine learning training application 110 generate or obtain synthetic training data.

The user interface 610 may further display estimation results as shown at 630. In some embodiments, the estimation results 630 include an estimate \hat{n} of the number of additional data samples needed to meet or exceed the target validation score shown at user input 622 (subject to any correction factor entered at user input 624) for each of the validation score estimation functions selected by the user via the estimation options user input 626, and an indication of the regression function used for the estimate. In some embodiments, the estimation results 630 may each include an indication 632 as to whether each displayed value of estimate \hat{n} is an optimistic estimate or a pessimistic estimate (e.g., as determined by the training data collection estimation function 112). For example, a “p” or other symbol may be used to indicate a pessimistic estimate while an “o” or other symbol may be used to indicate an optimistic estimate. In some embodiments, an appearance of the estimate value is used (e.g., a color) to indicate whether the estimate is pessimistic or optimistic. In some embodiments, when more than one validation score estimation functions is selected by the user (e.g., via user input 626), the estimation results 630 may be sorted based on the value of \hat{n}, and/or include other symbology indicating the bounds of the range of \hat{n} solved from the different validation score estimation functions

In some embodiments, the user interface 610 may further include a graphical display 640 comprising one or more performance (e.g., validation score) verses data set size curves computed for each of the validation score estimation functions (shown at V_{f-est}(1), V_{f-est}(2), V_{f-est}(3), V_{f-est}(4) in this example). As shown at 640, the graphical display may include a target line 642 indicating the target validation score so that the user may readily ascertain the data set size at which each validation score estimation function intersects the target validation score. Moreover, in some embodiments, the graphical display 640 may further include a ground truth curve such as computed from the linear score function of ground truth, v(n), discussed herein. The ground truth may be used by the user to further assess the degree of optimism and/or pessimism of the estimates generated by the training data collection estimation function 112.

Example Computing Device

FIG. 7 is a block diagram of an example computing device(s) 700 suitable for use in implementing some embodiments of the present disclosure, such as but not limited to the machine learning model training system 105. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s) such as HMI display 130), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. In some embodiments, the machine learning model 114 is implemented by one or more of the GPU(s) 708. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs. In some embodiments, the user interface for display by HMI display 130 (e.g., such as the user interface 610 of FIG. 6) is generated by the GPU(s) 708.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units(TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that enable the computing device 700 to communicate with other computing devices via an electronic communication network, included wired and/or wireless communications. In some embodiments, one or more components of the machine learning model training system may be coupled to the network 115 by the communication interface 710. The communication interface 710 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may enable the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that enable detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to enable the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

Example Data Center

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816(N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 822, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 822 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 822. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, such tools, services, software or other resources to train one or more machine learning models may include one or more components of the machine learning model training system 105 such as the machine learning model training application 110 and/or the training data collection estimation function 112. For example, a machine learning model(s), such as machine learning model 114, may be trained by calculating weight parameters according to a neural network architecture using software, machine learning model training application 110, and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s) (e.g., such as network 115), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). For example, in some embodiments, the data store 118 may be implemented as cloud storage in such a cloud-based network environment. Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element

A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more processing units to:
receive a first training data set comprising a first number of training samples;
compute, based at least on re-training a machine learning model over a plurality of iterations using a regression data set, at least one validation score for one or more iterations of the plurality of iterations, the regression data set being sampled from the first training data set;
determine a second number of training samples based at least on a target validation score; and
cause a display to present the second number of training samples.

2. The processor of claim 1, wherein the one or more processing units compute the at least one validation score by deriving at least one validation score estimation function.

3. The processor of claim 1, wherein the one or more processing units compute the at least one validation score by deriving at least one validation score estimation function, wherein one or more parameters of the at least one validation score estimation function are determined by curve fitting the at least one validation score corresponding to one or more iterations of the plurality of iterations.

4. The processor of claim 1, wherein the one or more processing units compute the at least one validation score by deriving at least one validation score estimation function, further wherein the at least one validation score estimation function is solved by, at least in part, minimizing the second number of training samples subject to the at least one validation score estimation function having a value greater than the target validation score.

5. The processor of claim 1, wherein the regression data set comprises a plurality of subsets of training data generated from the first training data set and the at least one validation score is associated with a respective subset of training data of the plurality of subsets of training data.

6. The processor of claim 1, wherein the one or more processing units are further to:
determine a correction factor; and
determine the second number of training samples based at least on a sum of the target validation score and the correction factor.

7. The processor of claim 6, wherein the correction factor is computed from a second training data set used to train a second machine learning model.

8. The processor of claim 1, wherein the one or more processing units are further to:
determine a linear score function of ground truth based at least in part on training the machine learning model using the first training data set.

9. The processor of claim 8, wherein the one or more processing units are further to:
compute a data collection ratio based at least in part on the linear score function of ground truth, the second number of training samples, and the first number of training samples; and
wherein the correction factor is computed to generate a ratio greater than one for the data collection ratio.

10. The processor of claim 1, wherein the one or more processing units compute the at least one validation score by deriving at least one validation score estimation function, the at least one validation score estimation function comprising a concave monotonic increasing regression function.

11. The processor of claim 10, wherein the one or more processing units are further to:
determine an error in the second number of training samples based at least on the linear score function of ground truth; and
cause the display of the error in the second number of training samples.

12. The processor of claim 10, wherein the one or more processing units are further to:
compute a data collection ratio based at least on part on the linear score function of ground truth, the second number of training samples, and the first number of training samples; and
cause the display to indicate at least one of an optimism indication or a pessimism indication for the at least one validation score estimation function based at least on the data collection ratio.

13. The processor of claim 1, wherein the one or more processing units compute the at least one validation score by deriving a plurality of validation score estimation functions, and the one or more processing units are further to:
solve each of the plurality of validation score estimation functions to determine, based at least on the target validation score, a respective second number of training samples; and
cause the display to present each of the respective second number of training samples.

14. The processor of claim 1, wherein the one or more processing units are further to receive an input indicating the target validation score for training the machine learning model.

15. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

16. A system comprising:
one or more processing units to:
access a data store comprising a first training data set including a number of training samples;
generate a regression data set using the first training data set, the regression data set comprising a plurality of subsets of training data generated using the first training data set;
re-train the machine learning model over a plurality of iterations using the regression data set;
compute a plurality of validation scores using at least a first validation score estimation function, the plurality of validation scores comprising a respective validation score for at least one iteration of the plurality of iterations;
determine, based at least on a target validation score and using the at least a first validation score estimation function, an additional number of training samples; and
perform one or more operations to indicate the determination of the additional number of training samples.

17. The system of claim 16, wherein the one or more processing units are further to cause display of a training data collection recommendation based at least on the additional number of training samples.

18. The system of claim 16, wherein the at least one validation score estimation function comprises a concave monotonic increasing regression function.

19. The system of claim 16, wherein the one or more processing units are further to:
curve fit the plurality of validation scores to compute one or more parameters of the at least one validation score estimation function.

20. The system of claim 16, wherein the one or more processing units are further to:
solve, based at least on a sum of the target validation score and a correction factor, the at least one validation score estimation function to determine another additional number of training samples.

21. The system of claim 20, wherein the one or more processing units are further to:
compute a data collection ratio for the at least one validation score estimation function based at least on a linear score function of ground truth computed at least in part by training the machine learning model using the first training data set, the additional number of training samples, and the number of training samples; and
wherein the correction factor is computed to generate a ratio greater than one for the data collection ratio.

22. The system of claim 16, wherein the one or more processing units are further to:
derive another validation score estimation function based at least on iteratively re-training the machine learning model using the regression data set to compute a second respective plurality of validation scores, the second respective plurality of validation scores comprising a respective validation score for each iteration of a plurality of iterations, wherein the another validation score estimation function comprises a concave monotonic increasing regression function different from the at least one validation score estimation function;
solve, based at least on the target validation score, the additional validation score estimation function to determine another additional number of training samples; and
cause the display to present the additional number of training samples and the another additional number of training samples.

23. The system of claim 16, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system incorporating one or more virtual machines (VMs);
a system implemented at least partially in a data center; or
a system implemented at least partially using cloud computing resources.

24. A method comprising:
determining a number of additional training data samples for re-training a machine learning model by, at least in part, solving at least one validation score estimation function wherein one or more parameters of the validation score estimation function is determined based at least in part on iteratively re-training the machine learning model.

25. The method of claim 24, further comprising:
generating a regression data set comprising a plurality of subsets of data generated from a training data set, wherein one or more parameters of the at least one validation score estimation function are computed during the iteratively re-training the machine learning model using the regression data set.

26. The method of claim 25, further comprising:
solving the at least one validation score estimation function to determine the number of additional training data samples to meet or exceed a target validation score.
